(19) United States
(12) Patent Application Publication
(10) Pub. No.: US 2010/0134297 A1
(43) Pub. Date: Jun. 3, 2010

(54) ACTIVITY MONITORING EYEWEAR

(76) Inventor: Curtis Baldwin, Amarillo, TX (US)

Correspondence Address: JAY M. SCHLOFF, 6960 Orchard Lake Road, Suite 315, West Bloomfield, MI, 48322, US

(21) Appl. No.: 12/327,142

(22) Filed: Dec. 3, 2008

(51) Int. Cl. G08B 5/22

(52) U.S. Cl. 340/573.1; 340/691.6; 340/850

(57) ABSTRACT

Disclosed is an activity monitoring eyewear for a swimmer. The activity monitoring eyewear includes a frame having a pair of hollow rim portions, an attachment member operatively coupled to the frame, and an at least one monitoring system configured on the attachment member. Each of the pair of hollow rim portions is configured to receive an image display lens. The attachment member is adapted to secure the frame on a head of the swimmer in a manner such that the image display lens is positioned in proximity to eyes of the swimmer. Further, the at least one monitoring system is operatively coupled to the image display lens and is capable of sensing the activity of the swimmer and relaying the information associated with the activity on the image display lens for display.

### FIELD OF THE INVENTION

The present invention relates generally to eyewear, and, more particularly, to an activity monitoring eyewear for a swimmer capable of sensing an activity of the swimmer and displaying information associated with the activity to the swimmer while swimming.

### BACKGROUND OF THE INVENTION

Typically, eyewear is used to protect eyes of a wearer from an ambient environment which may contain one or more hostile elements. These hostile elements includes, but are not limited to, air-borne particulates such as dust, dirt, smoke and the like; water; water-borne chemicals; air flow; and sunlight. Further, various types of eyewear are known in the art for different activities of the wearer. For instance, prescription eyewear is used for vision correction, goggles and sunglasses are used for protection of eyes from sunlight, and the like. Furthermore, athletic eyewear is also known in the art that finds its utility in sports and athletic events to protect the eyes of a player from the hostile elements and to enhance performance of the player in a given sport. An example of the athletic eyewear is swimming eyewear, also known as “goggles,” adapted to protect eyes of a swimmer from water; water-borne chemicals, microorganisms, and the like.

The swimming eyewear helps a swimmer to see underneath water while swimming. However, besides having a clear visibility underneath water, the swimmer may also prefer to know about physiological attributes such as heartbeat, and the like, in his/her body and also physical attributes, such as lap time and the like, while swimming. The physiological attributes and the physical attributes are hereinafter referred to as ‘activity’. Various monitoring devices are known in the art for measuring heart rate of a swimmer while swimming which are generally mounted on a wrist or various other locations on swimmer's body. For example, a monitoring device configured to be wrapped across a chest of the swimmer is capable of sensing the heartbeat of the swimmer and wirelessly transmitting measured signals to a receiver. However, such a monitoring device is inconvenient as the swimmer has to wear the monitoring device across his/her chest in order to get information associated with the activity. Further, to see the information associated with the activity, the swimmer has to keep a watch on the monitoring device, which in turn, distracts the focus of the swimmer and as such continuous, uninterrupted feedback of the information may not received by the swimmer. Furthermore, distraction caused by looking at the monitoring device may result in a loss of concentration and may also be a cause of possible injury to the swimmer.

Accordingly, there exists a need for a monitoring device which is capable of providing swimmer continuous, uninterrupted information associated with an activity. Further, there exists a need for a monitoring device configured on an eyewear configured to provide information associated with an activity to a swimmer without distracting concentration of the swimmer. Also, there exists a need for an activity monitoring eyewear which is lightweight, durable, attractive, and has low production cost.

### SUMMARY OF THE INVENTION

In view of the foregoing disadvantages inherent in the prior art, the general purpose of the present invention is to provide an activity monitoring eyewear for swimmers, configured to include all the advantages of the prior art, and to overcome the drawbacks inherent therein.

Therefore, an object of the present invention is to provide an activity monitoring eyewear for a swimmer capable of providing continuous, uninterrupted information associated with an activity to the swimmer in a most efficient manner.

Another object of the present invention is to provide an activity monitoring eyewear adapted to be positioned in proximity to eyes of a swimmer for providing continuous and uninterrupted information associated with an activity during swimming and as such avoiding distraction of the swimmer.

Yet another object of the present invention is to provide an activity monitoring eyewear for swimmer which is lightweight, durable, attractive, and has low production cost.

To achieve the above objects, in an aspect of the present invention, an activity monitoring eyewear for a swimmer is provided which is capable of sensing an activity of the swimmer and displaying information associated with the activity to the swimmer. The activity monitoring eyewear includes a frame having a pair of hollow rim portions, an attachment member operatively coupled to the frame, and an at least one monitoring system configured on the attachment member. Each of the pair of hollow rim portions is configured to receive an image display lens and the image display lens is capable of displaying the physiological information. The attachment member is adapted to secure the frame on a head of the swimmer in a manner such that the image display lens is positioned in proximity to eyes of the swimmer. Further, the at least one monitoring system is operatively coupled to the image display lens and is capable of sensing the activity of the swimmer and relaying the information associated with the activity on the image display lens for display.

This together with other aspects of the present invention, along with the various features of novelty that characterize the present invention, is pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 is a front view of an activity monitoring eyewear, in accordance with an embodiment of the present invention; and

FIG. 2 is a back view of the activity monitoring eyewear of FIG. 1, in accordance with an embodiment of the present invention.

Like reference numerals refer to like parts throughout the description of several views of the drawings.

### DETAILED DESCRIPTION OF THE INVENTION

The exemplary embodiments described herein detail for illustrative purposes are subject to many variations in structure and design. It should be emphasized, however, that the present invention is not limited to a particular activity monitoring eyewear, as shown and described. It is understood that various omissions and substitutions of equivalents are contemplated as circumstances may suggest or render expedient, but these are intended to cover the application or implementation without departing from the spirit or scope of the claims of the present invention.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

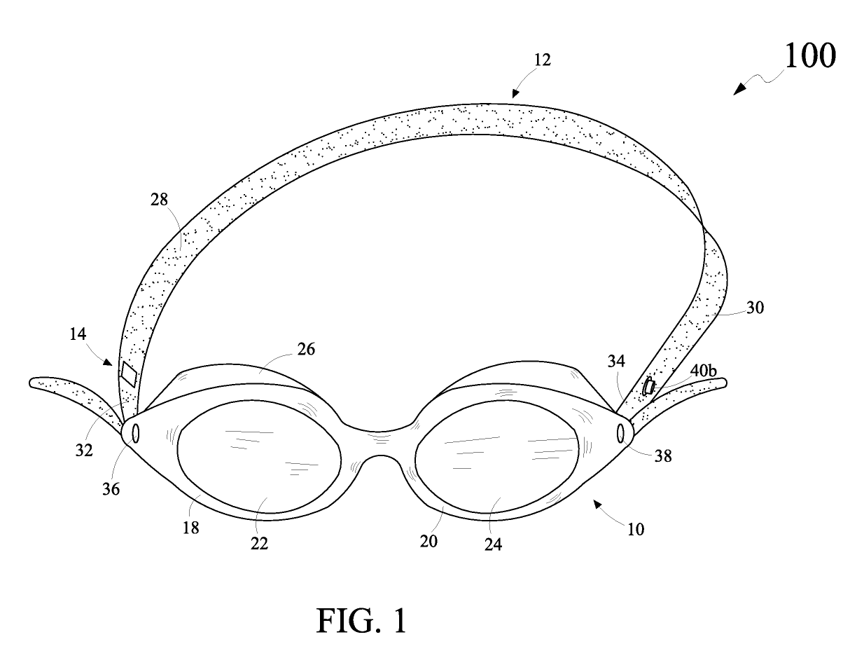

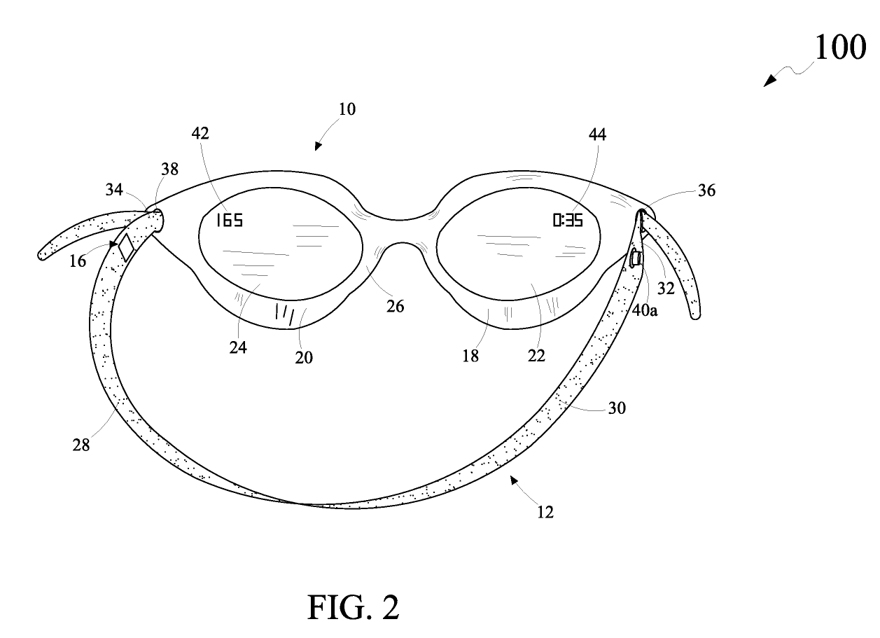

FIGS. 1 and 2 illustrate an activity monitoring eyewear 100 for a swimmer (not shown) capable of sensing an activity of the swimmer and displaying information associated with the activity. More specifically, FIG. 1 illustrates a front view of the activity monitoring eyewear 100 and FIG. 2 illustrates a rear view of the activity monitoring eyewear 100, in accordance with an embodiment of the present invention. The activity monitoring eyewear 100 includes a frame 10, an attachment member 12 operatively coupled to the frame 10, and at least one monitoring system such as a first monitoring system 14 and a second monitoring system 16 configured on the attachment member 12.

The frame 10 includes a pair of hollow rim portions such as a first hollow rim portion 18 and a second hollow rim portion 20. Each of the pair of the hollow rim portions such as the first hollow rim portion 18 and the second hollow rim portion 20 are configured to receive an optical image display lens such as a first image display lens 22 and a second image display lens 24, respectively. The first image display lens 22 and the second image display lens 24 may include a liquid crystal display (LCD), a light emitting diode (LED), a cathode ray tube (CRT) a digital micro-mirror device (DMD), a holographic display, a laser display or other optical image forming device. The image display lenses have information displaying capabilities and are transparent in order to allow the swimmer to see through the first image display lens 22 and the second image display lens 24 when the activity monitoring eyewear 100 is worn by the swimmer over his/her head. Further, an inner side (not shown) of the frame 10 may include a resilient covering 26 which is flexible. The resilient covering 26 is configured to provide an airtight attachment of the activity monitoring eyewear 100 on a face of the swimmer in order protect eyes of the swimmer from an ambient environment which may contain one or more hostile elements such as water, water-borne chemicals, microorganisms, and the like.

The frame 10 is secured on the face of the swimmer with the help of the attachment member 12. The attachment member 12 has an anterior side 28 and a posterior side 30. The attachment member 12 further includes a first side portion 32 and a second side portion 34 configured to attach with a first attachment receiving opening 36 and a second attachment receiving opening 38 of the frame 10 as shown in FIGS. 1 and 2. Further, the attachment member 12 may have a plurality of adjustment members (not shown) for adjustment and orientation of the frame 10. The attachment member 12 allows securement of the activity monitoring eyewear 100 on the head of the swimmer in a manner such that the frame 10 is positioned in proximity to the eyes of the swimmer and the attachment member 12 is in close contact with temples of the swimmer.

Further, the at least one monitoring system, such as the first monitoring system 14 and the second monitoring system 16, is configured on the attachment member 12 as shown in FIGS. 1 and 2. The at least one monitoring system includes a plurality of sensors (not shown) such as a heartbeat sensor for sensing heartbeat of the swimmer, a lap time sensor for sensing lap time of a swimmer while swimming, and the like. Physiological attributes of the swimmer such as the heartbeat and the like, and physical attributes such as lap time, are hereinafter referred to as ‘activity’. The at least one monitoring system further includes a battery housing (not shown) for holding a battery (not shown). The battery provides requisite energy for the operation of the plurality of sensors. Also, the at least one monitoring system, such as the first monitoring system 14 and the second monitoring system 16, includes an initiation reset button such as reset buttons 40a, 40b respectively, for initiating the plurality of sensors. In the present embodiment, the at least one monitoring system, such as the first monitoring system 14 and the second monitoring system 16, have been shown (FIGS. 1 and 2), however, it may be evident to a person skilled in the art the present invention is not limited to the number of monitoring systems and the same may not be construed as limiting the scope of the present invention.

Furthermore, the plurality of sensors of the at least one monitoring system is capable of sensing the physiological attributes of the swimmer, such as a heart rate, and relaying signals to the image display lens such as the first image display lens 22 and the second image display lens 24. The image display lens such as the first image display lens 22 and the second image display lens 24 is capable of receiving the signals from the at least one monitoring system and displaying information pertaining to the physiological attributes of the swimmer thereof. The at least one monitoring system is also capable of relaying signals associated with the lap time of the swimmer while swimming. The signals associated with the lap time of the swimmer are also received by the image display lens such as the first image display lens 22 and the second image display lens 24 and displayed thereof. The at least one monitoring system is capable of sensing the activity of the swimmer in an efficient manner and transmitting signals associated with the activity to the image display lens for displaying information associated with the activity in minimum time. The information associated with the activity is displayed on the image display lens such as the first image display lens 22 and the second image display lens 24 as a three dimensional image. In FIG. 2, a representative numeral 42 shown on the second image display lens 24 represents exemplary information associated with the physiological attribute such as the heartbeat of the swimmer and a representative numeral 44 shown on the first image display lens 22 represents an exemplary information associated with the physical attribute such as the lap time.

In use, the activity monitoring eyewear 100 is worn by the swimmer in a manner such that the frame 10 is positioned in front of the eyes of the swimmer. The resilient covering 26 of the frame 10 rests around the eyes of the swimmer in an airtight manner in order to protect the eyes of the swimmer from the hostile elements such as water, water-borne chemicals, microorganisms, and the like. The attachment member 12 of the activity monitoring eyewear 100 loops around the head of the swimmer in a manner such that portions of the attachment member 12 are in contact with the temple of the swimmer. The plurality of adjustment members of the attachment member 12 help to adjust and orient the frame 10. The at least one monitoring system, such as the first monitoring system 14 and the second monitoring system 16, operatively coupled on the attachment member 12 is initiated by the initiation reset button such as the reset buttons 40a, 40b. On initiation of the initiation reset button, the at least one monitoring system starts to sense the activity such as the physiological attributes and the physical attributes of the swimmer. More specifically, the plurality of sensors of the at least one monitoring system sense the activity of the swimmer and thereafter the at least one monitoring system generates signals associated with the activity. Further, the at least one monitoring system transmits the signal to the image display lens such as the first image display lens 22 and the second image display lens 24. The image display lens such as the first image display lens 22 and the second image display lens 24 receive the signals associated with the activity from the at least one monitoring system and displays the information associated with the activity thereof.

As explained in conjunction with FIGS. 1 and 2, an activity monitoring eyewear, such as the activity monitoring eyewear 100, may be used for providing information associated with the activity of the swimmer while swimming in minimum time and most efficient manner. The present invention provides the information associated with the activity automatically which is continually updated and displayed without necessitating the swimmer to pause in his/her activity. The information associated with the activity is displayed in focusing range of the swimmer on the image display lens such as the first image display lens 22 and the second image display lens 24. Further, the information associated with the activity is displayed to the swimmer without obstructing visibility and view of the swimmer. The present invention provides continuous and uninterrupted information associated with the activity during swimming and as such avoids distraction of the swimmer.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the claims of the present invention.

What is claimed is:

1. An activity monitoring eyewear for a swimmer, the activity monitoring eyewear capable of sensing an activity of the swimmer and displaying information associated with the activity, the activity monitoring eyewear comprising:
a frame having a pair of hollow rim portions, each of the pair of hollow rim portions configured to receive an image display lens, wherein the image display lens is capable of displaying the information;
an attachment member operatively coupled to the frame, the attachment member is adapted to secure the frame on a head of the swimmer in a manner such that the image display lens is positioned in proximity to eyes of the swimmer; and
at least one monitoring system configured on the attachment member, the at least one monitoring system operatively coupled to the image display lens,
wherein the at least one monitoring system is capable of sensing the activity of the swimmer and relaying the information associated with the activity on the image display lens for display of the information.

2. The activity monitoring eyewear of claim 1, wherein the at least one monitoring system comprises a plurality of sensors and an initiation reset button.

3. The activity monitoring eyewear of claim 2, wherein the plurality of sensors comprises a heartbeat sensor for sensing heartbeat of the swimmer.

4. The activity monitoring eyewear of claim 2, wherein the plurality of sensors comprises a lap time sensor for sensing lap time of the swimmer.
